(19) United States
(12) Patent Application Publication
(10) Pub. No.: US 2009/0016802 A1
(43) Pub. Date: Jan. 15, 2009

(54) Tethered writing pen with combination lock for un-tethering or ink refill access

(76) Inventor: Michael A. Castoro, Ronkonkoma, NY (US)

Correspondence Address: Thomas A. O'Rourke;Bodner & O'Rourke, LLP, Suite 108, 425 Broadhollow Road, Melville, NY, 11747, US

(21) Appl. No.: 12/215,673

(22) Filed: Jun. 27, 2008

Related U.S. Application Data
(60) Provisional application No. 60/937,619, filed on Jun. 28, 2007.

(51) Int. Cl. B43K 23/02; E05B 73/00

(52) U.S. Cl. 401/131; 70/58

(57) ABSTRACT

A tethered pen and base assembly is disclosed The assembly includes a first tether that is secured to the base at one end thereof and secured to a locking mechanism at an opposite end of the tether. A second tether is secured to the pen at one end thereof and to the locking mechanism at an opposite end of the second tether The locking mechanism releases an end of the tether when unlocked.

This application claims priority on U.S. Application Ser. No. 60/937,619 filed Jun. 28, 2007, the disclosures of which are incorporated herein by reference.

### FIELD OF INVENTION

This invention relates to pen-type devices which are securely tethered to a moveable or fixed base, and more particularly security devices permitting quick, tool-free un-tethering and replacement of a pen assembly or ink refill cartridge.

### BACKGROUND OF INVENTION

The United States Post Office, Banks, and many other places of business provide pens for its clientele to address letters and packages, fill out forms and applications, and endorse documents. The ready availability of a writing instrument facilitates quicker transactions, thus permitting greater business efficiency, and yet also provides a more organized, convenient, and customer-friendly business environment.

A high volume business location experiences higher costs due to theft or inadvertent retention of the pens. To reduce costs and inconvenience through misappropriation, a myriad of unique methods have evolved for tethering a writing instrument, such as a lead pencil or ink pen. Some inventions date back well over century. Many such inventions have been tailored to accommodate particular aspects of a business's operation or location. For instance, a retractably, tethered pen is well suited for a drive thru bank location.

A further consideration that has not heretofore been adequately addressed concerns increased costs from high rates of business activity with corresponding high usage of the pens. One pen could be completely used within a few days at a busy post office branch or bank location. It is not uncommon to find such pens out of ink and unattended because of the succession of steps that must be taken to accomplish replacement. Generally, replacement means use of a tool to free the pen, disposal of the entire pen, and finally attachment of a replacement pen, or in another possible arrangement, a tool could be required to simply replace the ink cartridge. In other cases, replacement might entail disposal of the entire pen-tether-stand assembly which may be bonded or fastened to the writing surface.

These methods are neither convenient nor cost effective. The owner of a Mont Blanc pen would no doubt seek to replace the ink refill rather than dispose of an entire gold-plated executive instrument. The situation is analogous where a business concern maintains a line of service counters with pens that must be changed every few days. Furthermore, many such businesses seek to provide a plush business environment—from the wall art displayed, to comfortable furniture in waiting areas, to the pens awaiting use at a counter. A cheap disposable pen is not compatible with such a plush atmosphere. Also, while some nicer pen arrangements may permit the two halves to unscrew for replacement of the ink refill, such an arrangement often falls prey to pranks and playful children who may unscrew and retain the parts as a toy, while waiting for the adult's business transaction to conclude. This similarly results in the need for complete replacement, but of the entire, more expensive pen assembly.

The solution for both scenarios lies in quick, tool-free replacement of a modest quality pen, or in replacement of inexpensive ink refill cartridges for a higher quality writing instrument.

### DESCRIPTION OF THE PRIOR ART

One series of patents disclose various retractably tethered arrangements which are uniquely designed for attachment to a fixture. A simple, retractably tethered pencil holder is shown in U.S. Pat. No. 264,593, which features a chord and spring-loaded reel for extension and retraction of the pencil holder. The tail end of the pencil is press-fit into a retaining cap which has an eyelet on the opposite end. The eyelet permits the pencil/cap combination to hook to an open-ended eyelet that is secured to the retraction chord. The pencil holder and reel arrangement was adapted for mobile use by providing a pin on the reel, permitting the entire pencil holder to be fastened to apparel. A similar retractable reel arrangement is shown in U.S. Pat. No. 2,961,257. But this 1957 invention is without the eyelets, having a more streamlined scheme for attaching the pen to a chain. It was further adapted so that the pen itself could be secured to its housing once retracted, in order to permit convenient use at a bank ATM where the depositor remains in his vehicle while completing a transaction. U.S. Pat. No. 6,065,892 discloses another retractable pen assembly, but one that is more generically suited for mounting to any wall location.

A second series of patents disclose retractable tether arrangements, but are uniquely designed for countertop use. U.S. Pat. No. 5,358,348 describes a simple retractably tethered pen where the cable automatically retracts into a desk-top stand, leaving the pen lying sideways or horizontally across the stand, elevated above the desk and ready for another user. U.S. Pat. No. 6,575,649 covers a desk-top configuration where the pen is positioned vertically in a stand and is tethered by cable to a reel. However, when the pen is in use and the cable has been extended, there is no tension on the cable. The cable remains slack until the pen is replaced in the holder, which then triggers a release that permits the spring-loaded reel to retract and coil the cable. U.S. Pat. No. 7,150,575 reveals a multifunction office stand including a business card holder, a post-it dispenser, paper tray, and a free swinging retractable pen that hangs from a vertical wall of the stand.

Another series of patents disclose a tether arrangement without a coiled retraction means, but instead utilize a spring method. U.S. Pat. No. 1,511,167 offers a pencil holder arrangement where a long slender spring protrudes vertically from a weighted circular base. A chord is attached to the top of the spring, and the other end is secured to a tabbed cylinder through which a pencil is press-fit. The pencil thus dangles near the base, and with the elasticity of the spring it would stretch to accommodate a patron's use. U.S. Pat. No. 2,027,857 provides a similar but improved arrangement whereby metal balls within the spring relieve some spring-back tendency while angled downward when the pencil is being used. Also, the tail end of the pencil is secured into a ring by means of a set screw rather than being press-fit into a cylinder.

The invention disclosed in U.S. Pat. No. 3,570,284 fulfills many of the goals discussed in the Background of the Invention section of this application. A pen is simply attached via a wire to a compact base which permits the pen to stand upright. The wire protrudes from the end of the pen and is retained within the pen housing by a spherical ball that is crimped to the wire. The shaft of the pen is composed of a one-piece housing into which is inserted a head or nose piece which retains the ink cartridge. However, the drawback of this invention is that the ink cartridge may only be accessed and replaced through use of a special tool which permits separation of the nose from the housing.

U.S. Pat. No. 5,368,406 unveils a pen which is not tethered whatsoever, but incorporates a combination lock into its housing which merely inhibits extension of the ink cartridge. The lock would not permit the ink cartridge to contact the writing surface without first keying the combination, and thus provides security against inadvertent extension of the cartridge while the pen is perhaps contained within ones pocket, and additionally provides protection against unauthorized use.

### BRIEF SUMMARY OF THE INVENTION

The present invention is directed to providing apparatus in the form of a penholder or stand for countertop use or use on another surface, and means of tethering a pen to the holder. In a preferred embodiment, the pen and stand have a tether arrangement having a lock to permit quick release of the pen for replacement. The lock is preferably a combination lock. In another embodiment the combination lock is incorporated into the housing of the pen thus providing a unique means of tethering the pen and of securing the ink cartridge, but with easy access for both its un-tethering and/or for replacement of the ink cartridge. A significant limitation of prior art was an arrangement that secured the ink cartridge from tampering or theft, but in so doing required a tool to permit ink cartridge removal. The novelty of this embodiment creates secure yet tool-free access to the cartridge, or a replaceable pen assembly.

Devising a means of security without the need for a tool increases serviceability of a business's array of pens located at a busy counter. A tool need not be stored in a precise location allowing access by all persons who would be obligated to provide maintenance. Furthermore, service would no longer be impeded due to the tool being misplaced by a worker, or worse still, being accidentally thrown away or completely lost.

This invention alleviates such concerns by devising a means of locking the pen housing with a combination lock. Access to the ink cartridge merely requires toggling a plurality of rollers just like an ordinary combination bicycle lock. In a preferred embodiment, the lock has three rollers. More rollers are usually not necessary since the added security provided by additional rollers is not always necessary since many uses for this invention are in public places where an unauthorized working the lock to remove the pen would be spotted.

### BRIEF DESCRIPTION OF THE DRAWINGS

FIG. 1A shows top view of the preferred embodiment of the locked pen holder arrangement.

FIG. 1B shows a side view of the preferred embodiment of the locked pen holder arrangement.

FIG. 1C shows a perspective view of the preferred embodiment of the locked pen holder arrangement.

FIG. 2 shows the assembled penholder base and base plate cabled to the lock.

FIG. 2A contains a view illustrating the travel limit of the push rod, once it is secured in the housing, at which point the push rod is positioned to accept the ball and cable of the pen assembly.

FIG. 2B is a view showing the pen assembly or replacement pen assembly.

FIG. 3 is an exploded view of the parts that comprise the preferred embodiment of the tethered penholder arrangement.

FIG. 4A shows a perspective view of the housing.

FIG. 4B shows an end view of the housing.

FIG. 4C shows a perspective view of the push rod.

FIG. 4D shows an end view of the push rod.

FIG. 4E shows a side view of the push rod.

FIG. 4F shows a side view of the push rod rotated 180° from the view of FIG. 4E.

FIG. 4G shows a side view of the push rod rotated 90° from FIGS. 4E and 4F.

FIG. 4H is a side view of the housing of FIG. 4A.

FIG. 4I is a top view of the housing of FIG. 4A.

FIG. 5A is a side view of the base.

FIG. 5B is a cut away view of the base taken along A-A.

FIG. 5C is a perspective view of a roller.

FIG. 5D is an end view of the roller of FIG. 5C.

FIG. 5E is a cut away view of the roller of FIG. 5C.

FIG. 5F is a perspective view of the pin.

FIG. 5G is an end view of the pin.

FIG. 5H is a top view of the pin.

FIG. 5I is a side view of the pin.

FIG. 6 is a representation of the first alternative embodiment showing the assembled invention which incorporates the lock into the pen housing.

FIG. 7 is a representation of the second alternative embodiment showing the assembled invention which incorporates the lock into the penholder base.

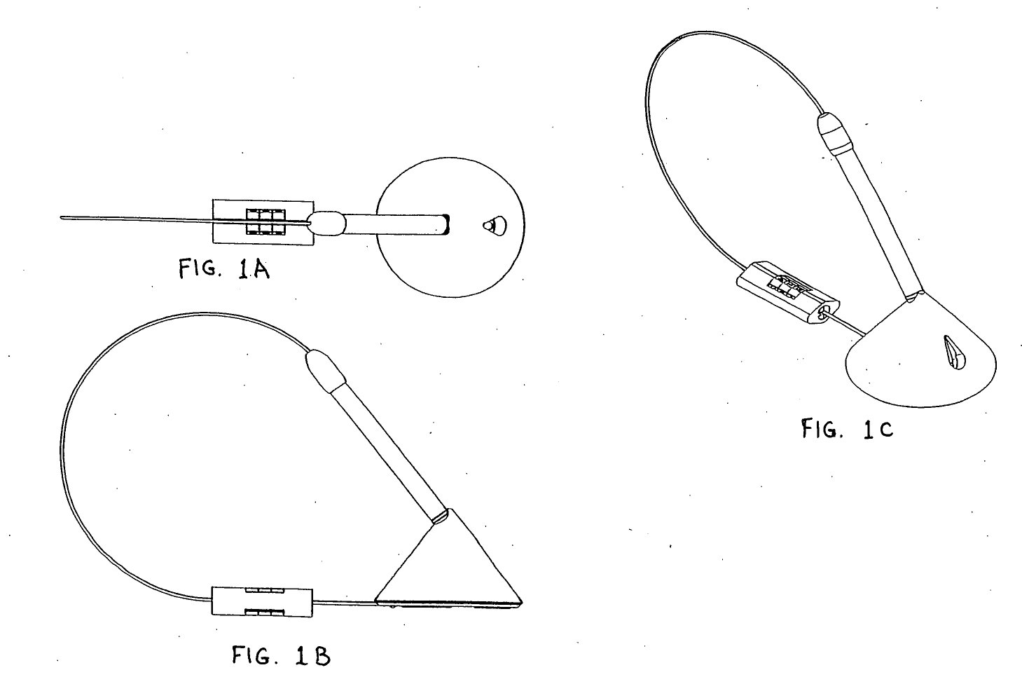

### DETAILED DESCRIPTION OF THE PREFERRED EMBODIMENTS

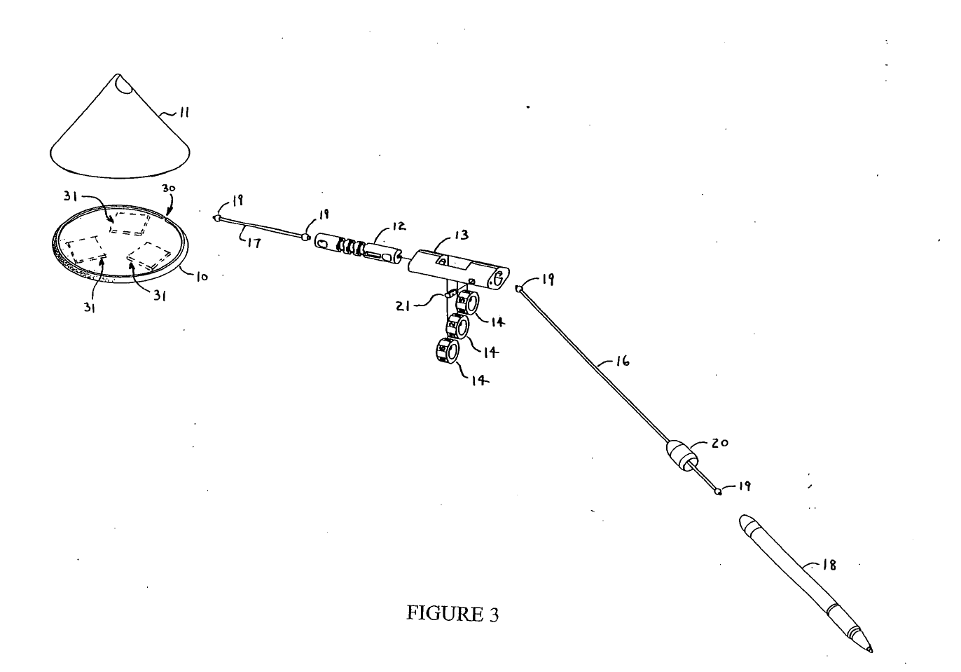

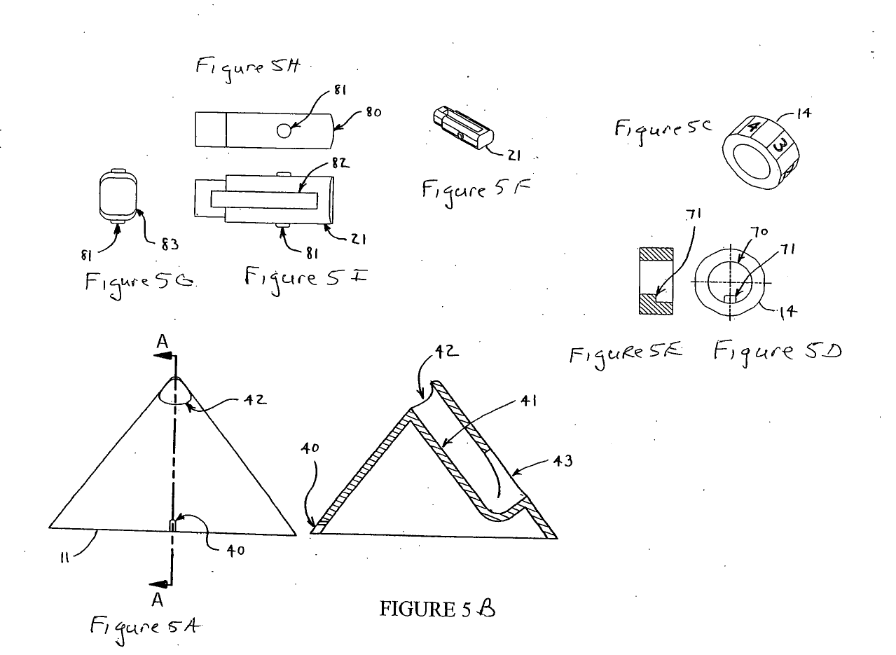

Per the exploded view in FIG. 3, the invention includes a penholder base 11 shown with a conical shape, but could optionally be any desired shape including but not limited to square-shaped, pyramid-shaped, rectangular, an up-right cylindrical shape, a horizontal cylindrical shape, a spherical shape, or even a freeform shape. The penholder base 11 is preferably hollowed out except for an inner wall 41, shown in FIG. 5, which may be parallel to the cone's slope to form an internal cylindrical shape. There is an opening 42 at the top of the cone at the end of the cylinder, which serves as the receptacle for the writing instrument. There is also an opening 43 in the cone towards the lower end of the cylinder to prevent a tight fit with the pen from creating an airlock that could make it difficult to remove the pen. This opening 43 is optional and could be eliminated by growing the cylindrical inner wall to be proportionately larger than the pen, thus permitting a looser fit that would not inhibit air flow once the pen is inserted.

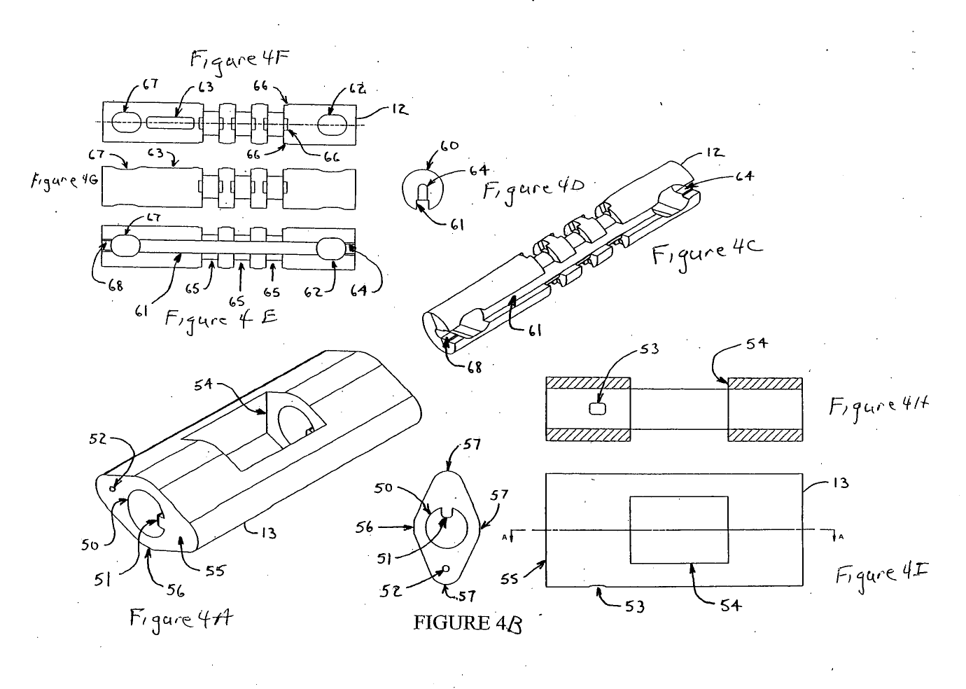

The conical penholder base 11 may sit atop the base plate 10. Base plate 10 has an angled outer edge to match or conform to the inner wall of the conical pen holder base 11. This would provide a means to glue or connect the base plate to the base. Alternatively the plate could be screwed into the base. Base plate 10 is shown with three integral, raised areas or lands 31 which may be utilized to bond the pen holder assembly to a countertop, or may alternatively have cushioning pads of cloth, rubber, or other non-abrasive material attached to them for simply resting the assembly upon a countertop. Also, base plate 10 could be a flat without the lands 31, and additionally could contain holes used for fixing or mounting the penholder assembly to a wall or counter top. The penholder base plate 10 has a small notch 30 (FIG. 3) which must be aligned on assembly with the notch 40 (FIG. 5) in penholder base 11 to allow the end of the tethering cable 17 to thread between the two, and be trapped by a ball 19 that is crimped on the end of the cable. The tethering cable could be secured to any suitable opening in the base or plate if desired. The cable 17 need not terminate with crimped ball 19 and could alternatively terminate with a crimped on cylinder or have the cable knotted at each end or other similar stop means to prevent the cable from being removed from the base. The tethering cable 17 may be made of string, wire, plastic, lamp style pull chain, or some combination thereof. The ball 19 on the other end of tethering cable 17 may be inserted into the slotted bore 62 (FIG. 4) in push rod 12, with the cable protruding out the end of the push rod through slotted bore 64.

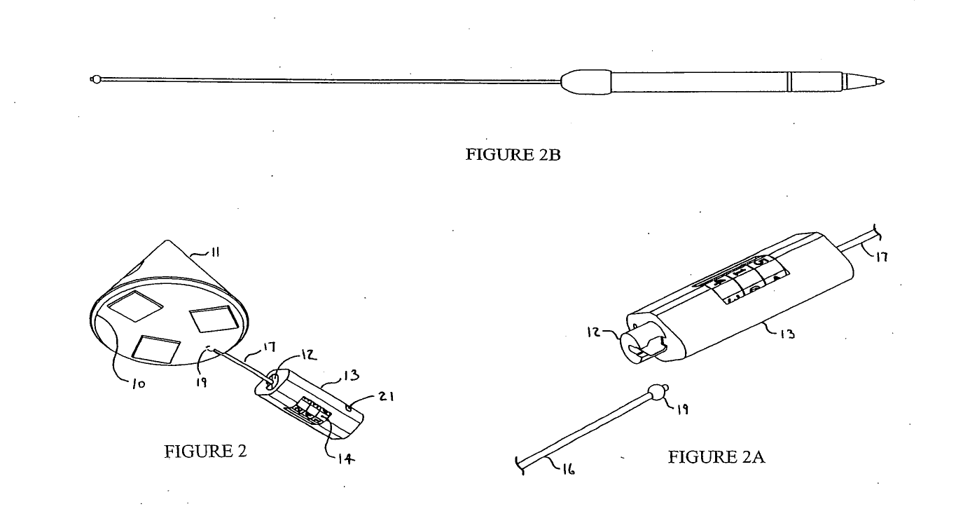

Push Rod 12 is shown as a cylinder for its entire axial length with a rectangular groove 61 running parallel to its axis for the entire length of the push rod. The shape of the push rod however can vary as desired. The circular portion of slotted bore 64 is concentric with the axis of push rod 12, while the width of slotted bore 64 is sufficient to run completely into rectangular groove 61, and is also of sufficient depth to reach the slotted bore 62. Slotted bore 62 is oriented transverse to the push rod axis. This arrangement permits the cable 17 with crimped ball 19 to nest within and be retained by the push rod 12 as shown in FIG. 2 and FIG. 2A. The opposite end of push rod 12 has a transverse slotted bore 67 equivalent to slotted bore 62, and also a slotted bore 68 concentric to the push rod 12 axis just like slotted bore 64. Immediately adjacent to slotted bore 67 in push rod 12 is a rectangular shaped recess 63 which is transverse to the cylinder axis and is clocked about 180 degrees opposite to channel grove 61. This feature, which will be discussed hereinafter, permits retention of the three rollers after assembly by limiting travel of the push rod within the housing.

Although shown as a cylindrical shape, push rod 12 need only be cylindrical for roughly half of its length, starting from the end with slotted bore 64 up to the start of recess 63. Beginning at recess 63 and to the end, other cross-sectional shapes could be used without affecting functionality of the lock mechanism, provided the cross section of that shape falls within the cylindrical envelope 60 of push rod 12 and were capable of retaining the cable 17 with crimped ball 19.

Push Rod 12 preferably also has three channel grooves 65 which run transverse to the push rod axis and 360 degrees radially about the periphery of the rod to produce three reduced diameter cylindrical cross-sections. The three grooves 65 are preferably of equal width and equally spaced on the push rod 12 axis such that the middle groove is offset slightly from the midpoint of the push rod 12 axis in the direction of slotted bore 64. Within these channel grooves 65 on each side wall thereof are shallow rectangular notches 66. There are three rectangular notches 66 per side wall and they are clocked 90 degrees apart radially about the push rod 12 periphery, with the middle notch located directly opposite the rectangular groove 61. There all 18 such notches 66.

Push rod 12 is so configured to be inserted into housing 13. Housing 13 is illustrated with a trapezoidal cross-section having generously rounded outside corners 57 (FIG. 4), but the cross-section could as well be square, rectangular, circular, or a free-form shape. One of those outside corners may be machined to have a flat face 56 which will later permit the housing to rest flush against a countertop. Housing 13 is bored out with an inner diameter 50 to match the outer diameter 60 of cylindrically-shaped Push Rod 12. But within that bore of housing 13 is a key 51 that must be aligned with rectangular groove 61 that runs the axial length of push rod 12, when the push rod is to be inserted into the housing.

Housing 13 has a small rectangular shaped opening 53 that is oriented transverse to the length of the housing, on the side opposite key 51. Opening 53 has internally radiused corners and is of sufficient depth to reach bore diameter 50. Opening 53 is located close to one end of housing 13. On that same end of housing 13, a round hole 52 is bored in the end face 55 with a depth sufficient to reach opening 53 and run past opening 53 an amount greater than or equal to the diameter of the bore. Hole 52 and opening 53 in housing 13 will accommodate pin 21 as discussed hereinafter. Housing 13 has a larger crosswise rectangular cutout 54 that runs transverse to the length of housing 13. The length and width of cutout 54 are sized for the side-by-side setting of rollers 14. There are preferably three rollers.

The rollers 14 are shown in FIG. 5 with an outer diameter upon which six flats are equally spaced around the periphery (hexagonal shape) to accommodate six stenciled numerals. The rollers 14 could also be shaped to accommodate fewer or additional flats, again being equally spaced (e.g., a pentagon shape, or heptagon, octagon . . . ), which would decrease or increase the possible numeric combinations visible on the housing face, only one of which would open the lock. The rollers 14 must be clocked to the proper orientation, or correct numeric combination, in order for the housing/roller arrangement to completely accept entry of push rod 12. This is so because the rollers 14 also have a bore 70 and key 71 (FIG. 5) which are equivalent to bore 50 and key 51 of housing 13. With the correct combination displayed, the key feature 51 of housing 13 is aligned with the respective key features 71 of each of the three rollers 14. The end of push rod 12 with slotted bore 68 may now be inserted into housing 13 fully, so that both ends of push rod 12 are coincident with the end faces of housing 13, and cable 17 is protruding from the tail end of push rod 12.

At this state of assembly, shown in FIG. 2, pin 21 may be inserted into opening 53 of housing 13. Pin 21 (FIG. 5) has a radiused rectangular cross-section 83 to match the dimensions of opening 53 in housing 13. Face 80 of pin 21 is rounded to match radius 57 of housing 13, allowing the pin, once inserted, to sit flush with the housing. Pin 21 may optionally have a rectangular cutout 82. Pin 21 contains two spring-loaded detents 81 which must initially be depressed to fully insert pin 21 into housing 13. The two detents 81, upon reaching bored hole 52 of housing 13, spring back and positively retain pin 21 with housing 13. Note that opening 53 in housing 13 and recess 63 in push rod 12 are positioned along their respective axes, as shown in FIG. 4, such that when pin 21 is inserted into opening 53 of housing 13, it limits travel of the push rod 12 in both directions. The travel limit is shown in FIG. 2A.

The cabled end of push rod 12 may at this point, and also at any time in the future as replacements pen are needed, be pushed to the travel limit within the housing 13 so as to expose slotted bore 67 of push rod 12. As shown in FIG. 2A, the pen assembly or replacement pen assembly may now be attached by inserting ball 19 that is crimped onto cable 16 into slotted bore 67, with the cable extending out the end of push rod 12 through slotted bore 68. This pen assembly or replacement pen assembly, shown in FIG. 2B, consists of cable 16, cap 20 with the cable threaded through the hole in the cap's end, and two balls 19 crimped onto the ends of cable 16. The cap 20 slides over crimped ball 19 and is shaped and sized to positively retain the end of pen 18.

The rollers can now be spun to a random setting to lock the tethered pen arrangement. The channel grooves 65 of push rod 12 accommodate the key 71 of the roller 14 as the roller's inner diameter 70 rotates about the Push Rod 12 outer diameter 60. Once in the locked condition, the shallow notches 66 of push rod 12, upon slow spinning of the rollers, provides a feel similar to when the roller's key 71 falls into the rectangular groove 61 on push rod 12. This feature prevents tampering, by an unauthorized person, through spinning the rollers to attempt to discover the combination by tactile sense.

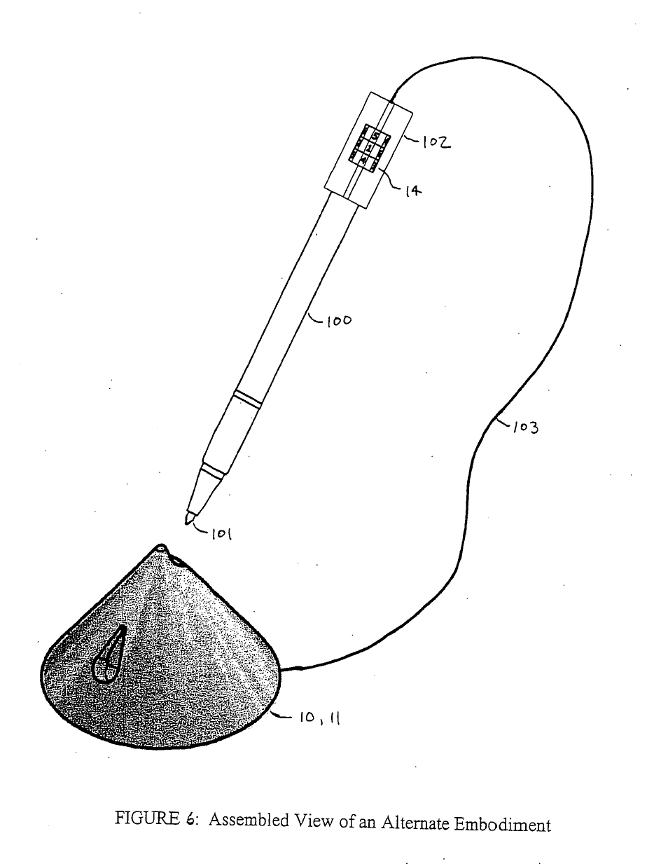

An alternative embodiment is shown fully assembled in FIG. 6. The penholder base 11 and base plate 10 are again used. The push rod 100 is lengthened and has a tapered end to accept and support an ink cartridge 101. The housing 102 is scaled down, and a single chord 103 has one end with a crimped ball 19 restrained within the push rod 100 by the housing. The other end of the cable 103 is threaded between the notch between penholder base 11 and base plate 10 and trapped there by the ball 19 crimped to the end of the cable. Three rollers 14 are set in housing 102 as with the first embodiment. Aligning the rollers to the proper combination permits separation of the housing and Push Rod and providing for removal and replacement of the ink cartridge or separation of the chord 103 from the housing 102.

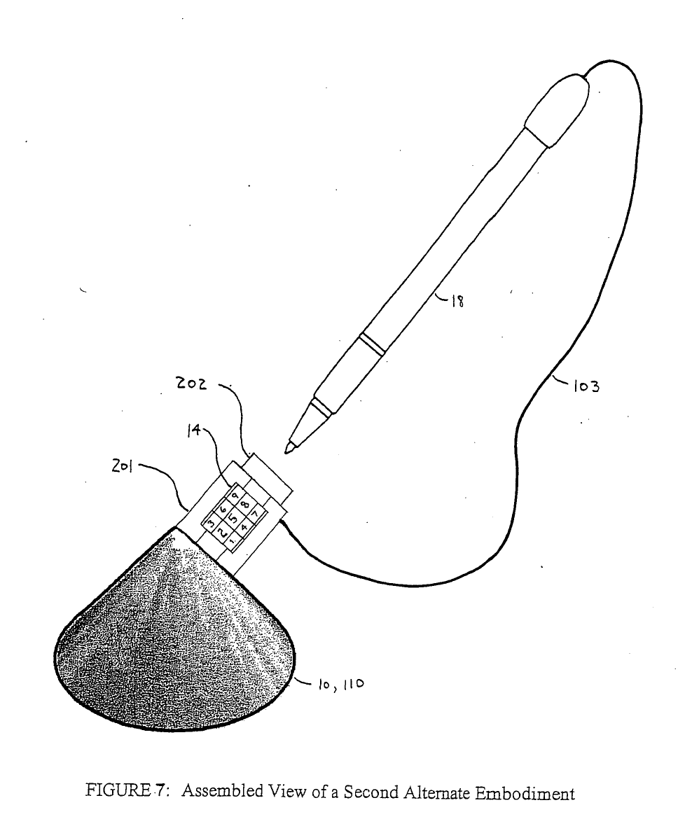

A second alternative embodiment is shown fully assembled in FIG. 7. Base plate 10 is again used. The penholder base 110 is similar to penholder base 10 but without the holes and inner wall. Penholder base 110 has a small flat for attachment of housing 201 which accepts the three rollers 14. Pushrod 202 provides the cylindrical shape to serve as a receptacle for the pen. Aligning the rollers to the proper combination permits separation of the pushrod from the housing and frees the chord 103. Cable 103 connects the cap 20 of pen 18 to the housing 201 via crimped balls 19 on each end.

As various changes could be made in the above constructions without departing from the scope of the invention, it is intended that all matter contained in the above descriptions shall be interpreted as illustrative and not in a limiting sense. In the views shown it can be seen that several objects of the invention are achieved with differing advantageous results attained.

I claim:

1. A tethered pen and base assembly comprising a first tether that is secured to said base at one end thereof and secured to a locking mechanism at an opposite end of said tether, a second tether that is secured to said pen at one end thereof and to said locking mechanism at an opposite end of said second tether, said locking mechanism releasing an end of said tether when unlocked.

2. The tethered pen and base assembly according to claim 1 wherein said locking mechanism comprises a push rod and a housing, said housing having a body with a first end a second end, said first end having an orifice for receiving at least a portion of said push rod.

3. The tethered pen and base assembly according to claim 2 wherein said push rod has a first end and a second end and wherein one end of said tether is removably secured to said first end such that when said push rod is released from said housing upon unlocking said end of said tether is released from said push rod.

4. The tethered pen and base assembly according to claim 3 wherein said push rod is generally cylindrical along at least a portion of its length.

5. The tethered pen and base assembly according to claim 4 wherein push rod has a groove extending along its length from one end thereof to the opposite end thereof.

6. The tethered pen and base assembly according to claim 5 wherein said push rod has a slotted bore for receiving an end of said tether.

7. The tethered pen and base assembly according to claim 6 wherein said push rod has a plurality of channel grooves transverse to the axis extending from one end of said push rod to the opposite end of said push rod.

8. The tethered pen and base assembly according to claim 7 wherein said channeled grooves have a plurality of notches on each sidewall of said channel grooves.

9. The tethered pen and base assembly according to claim 8 wherein said housing has a bore from at least one end thereof, said bore having a cross section such that the cross section of said bore mates with an outer cross section of said push rod.

10. The tethered pen and base assembly according to claim 9 wherein said housing has a key that aligns with said groove extending along the length of said push rod.

11. The tethered pen and base assembly according to claim 10 wherein said housing has one or more rollers, said rollers providing a combination for unlocking said push rod from said housing.

12. The tethered pen and base assembly according to claim 11 wherein said rollers must be clocked to a proper orientation in order for said housing to accept entry of said push rod into said housing.

13. The tethered pen and base assembly according to claim 12 wherein said rollers have a bore and a key which are adapted to align with a bore and key in said housing.

14. The tethered pen and base assembly according to claim 13 wherein said housing has an opening in an outer surface thereof and said push rod has an opening in a surface thereof for receiving a pin to limit the travel of said push rod in said housing.

15. The tethered pen and base assembly according to claim 14 wherein said pin has one or more spring loaded detents.

16. A lock assembly comprising, a push rod and a housing, said housing having a body with a first end a second end, said first end having an orifice for receiving at least a portion of said push rod, said push rod has a first end and a second end and wherein said push rod is generally cylindrical along at least a portion of its length, said push rod having a groove extending along its length from one end thereof to the opposite end thereof and a plurality of channel grooves transverse to an axis extending from one end of said push rod to the opposite end of said push rod, said housing having a key that aligns with said groove extending along the length of said push rod, said housing having one or more rollers, said rollers providing a combination for unlocking said push rod from said housing

17. The lock assembly according to claim 16 wherein said channeled grooves have a plurality of notches on each sidewall of said channel grooves.

18. The lock assembly according to claim 17 wherein said housing has a bore from at least one end thereof, said bore having a cross section such that the cross section of said bore mates with an outer cross section of said push rod.

19. The lock assembly according to claim 18 wherein said rollers must be clocked to a proper orientation in order for said housing to accept entry of said push rod into said housing.

20. The lock assembly according to claim 19 wherein said rollers have a bore and a key which are adapted to align with a bore and key in said housing.

21. The lock assembly according to claim 20 wherein said housing has an opening in an outer surface thereof and said push rod has an opening in a surface thereof for receiving a pin to limit the travel of said push rod in said housing.

22. The lock assembly according to claim 21 wherein said pin has one or more spring loaded detents.
